(19) United States
(12) Patent Application Publication
(10) Pub. No.: US 2013/0046505 A1
(43) Pub. Date: Feb. 21, 2013

(54) METHODS AND APPARATUSES FOR USE IN CLASSIFYING A MOTION STATE OF A MOBILE DEVICE

(71) Applicants: Christopher Brunner, San Diego, CA (US); Anthony Sarah, San Diego, CA (US); Pawan K. Baheti, Bangalore (IN); Leonard Henry Grokop, San Diego, CA (US)

(72) Inventors: Christopher Brunner, San Diego, CA (US); Anthony Sarah, San Diego, CA (US); Pawan K. Baheti, Bangalore (IN); Leonard Henry Grokop, San Diego, CA (US)

(73) Assignee: QUALCOMM INCORPORATED, San Diego, CA (US)

(21) Appl. No.: 13/209,886

(22) Filed: Aug. 15, 2011

(51) Int. Cl. G06F 15/00

(52) U.S. Cl. 702/141

(57) ABSTRACT

Methods and apparatuses are provided that may be implemented in a mobile device to establish an orientation invariant reference frame based, at least in part, on measurement values from a three-dimensional accelerometer fixed to the mobile device; transform subsequent inertial sensor measurements to the reference frame; and classify a motion state of the mobile device relative to the reference frame based, at least in part, on the transformed inertial sensor measurements.

### BACKGROUND

1. Field

The subject matter disclosed herein relates to electronic devices, and more particularly to methods and apparatuses for use in a mobile device to classify a motion state of the mobile device.

2. Background

Mobile devices, such as hand-held mobile devices like smart phones or other types of cell phones, tablet computers, digital book readers, personal digital assistants, gaming devices, etc., may perform a variety of functions. For example, certain mobile devices may provide voice and/or data communication services via wireless communication networks. Also, certain mobile devices may provide for audio and/or video recording or playback. Certain mobile devices further may provide for various applications relating to games, entertainment, electronic books, utilities, location based services, etc.

Some mobile devices, such as cell phones, personal digital assistants, etc., may be enabled to receive location based services enabled through the use of location determination technology including global navigation satellite systems (GNSS), indoor location determination technologies, and/or the like. In addition, some hand-held mobile devices have inertial sensors included to provide signals for use by a variety of applications including, for example, receiving hand gestures as user inputs or selections to an application, orienting a display to an environment, just to name a couple of examples.

Inertial sensors on a mobile device may, for example, provide sensor measurements for one or more axis of defining a Cartesian coordinate system (e.g., having orthogonal x, y, and z axes). Thus, for example, a three-dimensional accelerometer may provide acceleration measurements with respect to x, y, and z directions. In particular examples, an accelerometer may be used for sensing a direction of gravity toward the center of the earth and/or direction and magnitude of other accelerations (positive or negative). Similarly, a magnetometer (e.g., a compass) may provide magnetic measurements in one or more x, y, and/or z directions. Magnetometer measurements may be used, for example, in sensing magnetic North/South or determining true North/South for use in navigation applications. A gyrometer (e.g., a gyroscope) on the other hand may, for example, provide angular rate measurements in roll, pitch and yaw dimensions (e.g., angles relating to x, y, z axes).

In particular applications, a mobile device may attempt to characterize a “motion state” in which the mobile device may be moving. Examples of a motion state may include, for example, movement starting, movement stopping, turning left, turning right, walking, running, etc. Such a motion state may be derived or detected based, at least in part, on inertial sensor measurements. For example, inertial sensor measurements may be provided according to a device-centric coordinate system (e.g., an xyz Cartesian coordinate system) defined according a mobile device.

Characterizing or classifying a motion state using inertial sensor measurements may be difficult at times since an orientation of a mobile device may vary. For example, if a mobile device is being carried in a pocket or a car in some random orientation, and it is desired to know a motion state of the mobile device relative to a heading, merely processing acceleration measurements relative to a device-centric coordinate system may not be sufficient.

### SUMMARY

In accordance with certain aspects of presented herein, various methods and apparatuses are provided that may be implemented, for example, in a mobile device to classify a motion state relative to a reference frame based, at least in part, on inertial sensor measurements.

In certain example implementations, a method may be provided and implemented at a mobile device, which establishes a reference frame having an estimated vertical vector corresponding to a first one of a plurality of eigenvectors having a greatest magnitude and an estimated horizontal vector corresponding to a second one of the plurality of eigenvectors having a second greatest magnitude, the plurality of eigenvectors being based, at least in part, on measurement values from a three-dimensional accelerometer fixed to the mobile device; transforms inertial sensor measurements to the reference frame; and classifies a motion state relative to the reference frame based, at least in part, on the transformed inertial sensor measurements.

In certain other example implementations, an apparatus may be provided for use in a mobile device, wherein the apparatus comprises means for establishing a reference frame having an estimated vertical vector corresponding to a first one of a plurality of eigenvectors having a greatest magnitude and an estimated horizontal vector corresponding to a second one of the plurality of eigenvectors having a second greatest magnitude, the plurality of eigenvectors being based, at least in part, on measurement values from a three-dimensional accelerometer fixed to the mobile device; means for transforming inertial sensor measurements to the reference frame; and means for classifying a motion state relative to the reference frame based, at least in part, on the transformed inertial sensor measurements.

In still other example implementations, a mobile device may be provided which comprises at least one inertial sensor to generate inertial sensor measurements, the at least one inertial sensor comprising a three-dimensional accelerometer fixed to the mobile device; and a processing unit to establish a reference frame having an estimated vertical vector corresponding to a first one of a plurality of eigenvectors having a greatest magnitude and an estimated horizontal vector corresponding to a second one of the plurality of eigenvectors having a second greatest magnitude, the plurality of eigenvectors being based, at least in part, on measurement values from the three-dimensional accelerometer fixed to the mobile device; transform inertial sensor measurements to the reference frame; and classify a motion state relative to the reference frame based, at least in part, on the transformed inertial sensor measurements.

In yet other example implementations, an article of manufacture may be provided comprising a non-transitory computer-readable medium having computer-implementable instructions stored therein that are executable by a processing unit of a mobile device to establish a reference frame having an estimated vertical vector corresponding to a first one of a plurality of eigenvectors having a greatest magnitude and an estimated horizontal vector corresponding to a second one of the plurality of eigenvectors having a second greatest magnitude, the plurality of eigenvectors being based, at least in part, on measurement values from a three-dimensional accelerometer fixed to the mobile device; transform inertial sensor measurements to the reference frame; and classify a motion state relative to the reference frame based, at least in part, on the transformed inertial sensor measurements.

### BRIEF DESCRIPTION OF DRAWINGS

Non-limiting and non-exhaustive aspects are described with reference to the following figures, wherein like reference numerals refer to like features throughout the various figures unless otherwise specified.

FIG. 1 is a schematic block diagram illustrating an environment that includes a mobile device comprising a motion state detector for use in classifying a motion state of the mobile device, in accordance with an implementation.

FIG. 2A is an illustrative diagram showing an example mobile device in relationship to a device-centric coordinate system having three orthogonal axes, in accordance with an implementation.

FIG. 2B is an illustrative diagram showing a mobile device, for example, as in FIG. 2A, arranged in a particular orientation with respect to an orientation-invariant reference frame, in accordance with an implementation.

FIG. 3 is an illustrative diagram showing that an example mobile device may be arranged in various different positions with regard to a user's body, in accordance with an implementation.

FIG. 4 is a schematic block diagram illustrating certain features of an example mobile device, for example, as in FIG. 1, capable of classifying a motion state of the mobile device based, at least in part, on measurements from one or more inertial sensors, in accordance with an implementation.

FIG. 5 is a flow diagram illustrating certain features of an example process for use in a mobile device to classify a motion state of the mobile device based, at least in part, on measurements from one or more inertial sensors, in accordance with an implementation.

### DETAILED DESCRIPTION

According to certain example implementations, a mobile device may be provided which is able to classify its “motion state” based, at least in part, on measurements relating to changes in movements of the mobile device as detected using one or more inertial sensors, such as, for example, one or more accelerometers, one or more gyrometers, one or more magnetometers, and/or the like.

A mobile device may comprise a cell phone, a smart phone, a computer, a navigation aid, a digital book reader, a gaming device, music and/or video player device, a camera, etc., just to name a few examples.

A motion state may indicate that a mobile device is likely moving in some manner (e.g., a user of the mobile device may be walking, running, being transported, etc., while carrying the mobile device). Movement of a mobile device may, for example, be estimated to be along a particular direction of motion (e.g., a heading with respect to a reference frame, etc.). Thus, in certain instances, a motion state may, for example, indicate that a mobile device may be deviating (or may have recently deviated) from a particular estimated direction of motion, e.g., as might result from a turn to the left or right, and/or an increase or a decrease in an elevation. In certain instances, a motion state may, for example, also indicate or otherwise relate in some manner to an estimated position of the mobile device with respect to a user (e.g., based on a model of a user body).

In certain instances, a motion state may, for example, indicate that a mobile device may be being transported by a user while walking, by a user while riding in a moving vehicle, etc. In certain instances, a motion state may, for example, indicate that a person may be standing, sitting, lying down, etc. Of course these are just a few examples and, as with all of the examples presented herein, claimed subject matter is not necessarily so limited.

In certain example implementations, to determine a motion state of a mobile device, a mobile device may first determine its orientation with regard to an orientation-invariant reference frame (hereinafter, simply referred to as a “reference frame”). A reference frame may, for example, be established based, at least in part, on measurement values from a three-dimensional accelerometer fixed in some manner to (e.g., within) the mobile device. Subsequent inertial sensor measurements (e.g., from the three-dimensional accelerometer, a three-dimensional gyrometer, a three-dimensional magnetometer, and/or the like) may be transformed according to a determined orientation of the mobile device relative to the reference frame. A motion state may then be determined based, at least in part, on the transformed inertial sensor measurements.

As described in greater detail in the examples below, in certain implementations, a reference frame may be based, at least in part, on certain eigenvectors (e.g., characterizing an estimated vertical vector, an estimated horizontal vector). Inertial sensor measurements may then be transformed by applying a rotation matrix based, at least in part, on the eigenvectors to certain inertial sensor measurements.

In one particular example implementation, a mobile device may be carried by a user (e.g., in a shirt pocket, a hip holster, a bag, a hand, etc.), while the user may be walking, or possibly being transported by an automobile, and/or the like. Using well known techniques (e.g., plotting location fixes of the mobile device using a Kalman filter, particle filter, etc.), a heading or direction of motion may be estimated. Here, it may be desired to establish a motion state relative to a direction of motion or heading such as turning left or right (or otherwise deviating from a heading). In a particular example implementation, an orientation of a mobile device may be determined relative to an estimated heading using, for example, inertial sensor measurements as discussed above. In certain instances, a direction of motion may be identified as being generally parallel to a heading and/or possibly deviating from a heading as determined based, at least in part, on transformed inertial sensor measurements. Inertial sensor measurements may be transformed (e.g., adapted, mapped, etc.) from a device-centric coordinate system (e.g., defined according to features of a device) to a coordinate system defined, at least in part, according to an estimated direction of motion or heading (e.g., with respect to a reference frame). The transformed inertial sensor measurements may then be used for evaluating a motion state.

With this in mind and by way of further introduction, in certain example implementations a mobile device may determine its orientation relative to a reference frame based, at least in part, by establishing a matrix of measurement values from a three-dimensional accelerometer fixed to the mobile device, performing eigendecomposition on the matrix of measurement values to determine a plurality of eigenvectors, and establishing a reference frame based, at least in part, on an estimated vertical vector corresponding to a first one of the eigenvectors having a greatest magnitude and an estimated horizontal vector corresponding to a second one of the eigenvectors having a second greatest magnitude. Hence, in determining an orientation of a mobile device, a reference frame may be established which may be invariant to the orientation of the mobile device and which may be used to understand subsequently generated inertial sensor measurements.

In certain example implementations, a matrix of accelerometer measurement values may be based, at least in part, on a plurality of inertial sensor measurements from a three-dimensional accelerometer which have been combined in some manner. In certain example instances, a plurality of inertial sensor measurements may be gathered over a period of time from a three-dimensional accelerometer and combined (e.g., average of outer product of accelerometer vector readings over a duration of 5 seconds, where accelerometer vector denotes accelerometer readings in all three axes) to form a matrix of accelerometer measurement values.

Accordingly, a matrix of accelerometer measurement values may relate to a particular period of time. For example, a period of time may relate to one or more periods of time during which accelerometer measurement values may be determined based, at least in part, on inertial sensor measurements from a three-dimensional accelerometer. In certain example implementations, a period of time may be fixed (e.g., a particular number of seconds), or may be dynamically determined (e.g., based on some formula, based on a threshold quality and/or quantity of measurements, using a sliding window, etc.). In certain example implementations, a period of time may be based, at least in part, on one or more other operations performed or supported by the mobile device. For example, a period of time may be based, at least in part, on a pedometer operation, e.g., set based on a pedometer stride value indicating a particular number of steps, and/or an estimated time for a user to complete a particular number of steps, etc. In other example implementations, an Infinite Impulse Response (IIR) filter and/or the like may be used, e.g., to take into account past accelerometer readings.

Having established a matrix of measurement values, a mobile device may then perform eigendecomposition on the matrix to determine a plurality of eigenvectors. In certain example implementations, eigendecomposition may be performed using Jacobi iterations, and/or other like well known iterative algorithmic techniques.

A reference frame may then be established based, at least in part, using orthogonal vectors such as an estimated vertical vector and an estimated horizontal vector. For example, a strongest eigenvector (e.g., having a greatest relative magnitude) may be generally parallel to a gravity vector and may be used to represent an estimated gravity vector. An estimated horizontal vector, corresponding to the second strongest eigenvector may at times be generally parallel to an estimated motion direction vector (e.g., as determined for a period of time). Accordingly, an orientation of a mobile device with respect to gravity and direction of motion may be determined based, at least in part, using the resulting eigenvectors. For example, an orientation may be indicated via a rotation matrix established based, at least in part, on the eigenvectors.

Since a mobile device may be moved about while be carried, it may be beneficial to determine an orientation of the mobile device from time to time, or in response to certain events. For example, an orientation with respect to a reference frame may be updated or refreshed according to some schedule, based on one or more functions (thresholds), one or more operations, and/or some combination thereof, and/or the like.

Having established its orientation (e.g., using a reference frame), a mobile device may then transform subsequent inertial sensor measurements to the reference frame based, at least in part, on the orientation. For example, a rotation matrix may be used to transform subsequent inertial sensor measurements from a device-centric coordinate system to a reference frame. A mobile device may then classify (i.e., determine) its motion state based, at least in part, on the transformed inertial sensor measurements. For example, a mobile device may classify its motion state as turning left or right, and/or increasing or decreasing altitude.

In certain example implementations, at least a portion of the inertial sensor measurements may comprise accelerometer measurements and a mobile station may classify its motion state by comparing transformed inertial sensor measurements to estimate a vertical change in a direction of motion of the mobile device (e.g., as might be experienced with an increasing or decreasing altitude) with respect to the reference frame.

In certain example implementations, at least a portion of the inertial sensor measurements may comprise gyrometer measurements and a mobile station may classify its motion state by comparing transformed inertial sensor measurements to estimate a horizontal change in a direction of motion of the mobile device (e.g., as might be experienced with a turn) with respect to the reference frame.

In certain example implementations, at least a portion of the inertial sensor measurements may comprise magnetometer measurements and a mobile station may classify its motion state by comparing transformed inertial sensor measurements to estimate a heading change in a direction of motion of the mobile device (e.g., as might be experienced with a turn) with respect to the reference frame.

In certain example implementations, a mobile device may further classify its motion state by estimating its position with regard to a user (e.g., a model of a user body) based, at least in part, on selected eigenvectors. For example, a mobile device may infer that it may be positioned in a shirt pocket, a pant pocket (e.g., front, side, or back pockets), a hip holster (e.g., a carrying mechanism), near a hand (e.g., in a hand, or some carrier held by a hand, etc.) of a walking or running user based, at least in part, on certain eigenvectors.

In another example implementation, a motion state and device position classification may be based, at least in part, on features such as angular spherical coordinates e.g., derived from a second strongest eigenvector.

In certain example implementations, a mobile device may further affect one or more operations performed or supported by the mobile device based, at least in part, on a motion state and/or an estimated position of the mobile device with regard to the user. Thus, for example, one or more operations performed or supported by the mobile device may be initiated, halted, or otherwise affected in some manner based on an inferred motion state or estimated position. An operation may comprise, for example, a wireless communication operation, a navigation operation, a user interactive operation, a content recording or rendering operation, a data processing or data storage operation, or some combination thereof, just to name a few.

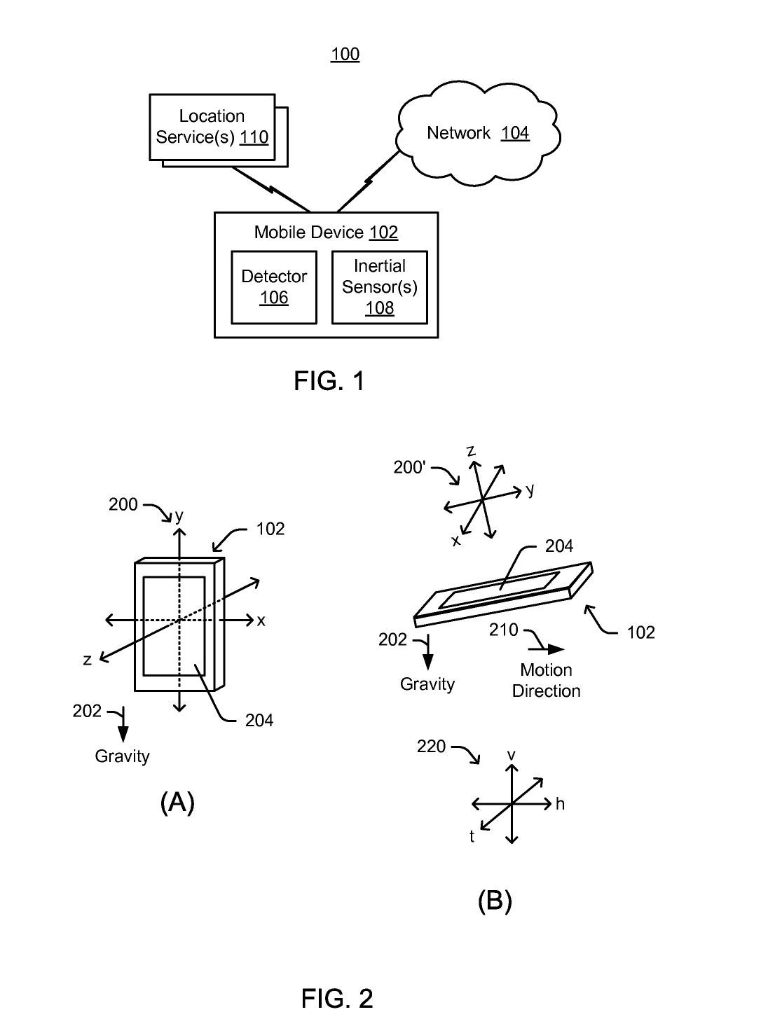

Attention is now drawn to FIG. 1, which is a schematic block diagram illustrating an environment 100 that includes a mobile device 102 comprising a motion state detector 106 and one or more inertial sensors 108 that may be used in classifying a motion state of mobile device 102, in accordance with an implementation.

Mobile device 102 may be representative of any electronic device capable of being transported within environment 100 (e.g., by a user). Motion state detector 106 may be representative of circuitry, such as, e.g., hardware, firmware, a combination of hardware and software, and/or a combination of firmware and software or other like logic may be provided in a mobile device to classify a motion state. Inertial sensor(s) 108 may be representative of one or more accelerometers, one or more gyrometers, one or more magnetometers, and/or the like or combinations thereof. In certain instances, an inertial sensor 108 may comprise microelectromechanical systems (MEMS) or other like circuitry components which may be arranged as a three-dimensional accelerometer, a three-dimensional gyrometer, a three-dimensional magnetometer, just to name a few examples.

In certain example implementations, mobile device 102 may function exclusively and/or selectively as a stand-alone device, and/or may provide a one or more capabilities/services of interest/use to a user. In certain example implementations, mobile device 102 may communicate in some manner with one or more other devices, for example, as illustrated by the wireless communication link to the cloud labeled network 104. Network 104 may be representative of one or more communication and/or computing resources (e.g., devices and/or services) which mobile device 102 may communicate with or through using one or more wired or wireless communication links. Thus, in certain instances mobile device 102 may receive (or send) data and/or instructions via network 104.

In certain example implementations, mobile device 102 may be enabled to use signals received from one or more location services 110. Location service(s) 110 may be representative of one or more wireless signal based location services such as, a Global Navigation Satellite System (GNSS), or other like satellite and/or terrestrial locating service, a location based service (e.g., via a cellular network, a WiFi network, etc.).

Mobile device 102 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

FIG. 2A is an illustrative diagram showing an example mobile device 102 in relationship to a (device-centric) coordinate system 200 having three orthogonal axes labeled x, y, and z, with an origin that may be placed at some reference point of the mobile device, in accordance with an implementation. A reference point may, for example, be centered or offset in some manner. As illustrated in this example, mobile device 102 has a rectangular box shape having its width correspond to the x axis, its length correspond to the y axis, and its depth correspond to the z axis of an example device-centric coordinate system 200. Additionally, in the illustrated orientation of mobile device 102, the y axis may be generally parallel to an acceleration of gravity as represented by a gravity vector 202. For illustrative purposes, example mobile device 102 also includes a display 204 (e.g., a main display, which may also serve as a touch screen). It should be understood that mobile device 102 is simply a representative illustration and that there are a variety of other forms (e.g., shapes, sizes, types, etc.) which a mobile device may take, and hence claimed subject matter is not so limited.

FIG. 2B is an illustrative diagram showing a mobile device 102, for example, as in FIG. 2A, arranged in a different orientation as illustrated by device-centric coordinate system 200′ with respect to gravity vector 202. Also illustrated is a reference frame 220, which may represent a coordinate system that is invariant to the orientation of mobile device 102. As shown, example reference frame 220 has three orthogonal axes labeled v (e.g., for vertical), h (e.g., for horizontal), and t (e.g., for turn). Thus, rather than having axes that are “fixed” to mobile device 102, reference frame 220 may, for example, be established based, at least in part, by an estimated vertical vector and an estimated horizontal vector relating to selected eigenvectors (e.g., based on the relative magnitudes of a plurality of eigenvectors). Thus, in this example reference frame 220, a vertical (v) axis may correspond to a strongest eigenvector which may be generally parallel to gravity vector 202 and a horizontal (h) axis may correspond to a second strongest eigenvector which may be generally parallel to an estimated direction of motion as illustrated by motion direction vector 210, which in certain instances may correspond to a heading. The remaining turn (t) axis may, for example, be identified as being orthogonal to the vertical and horizontal axes.

As previously mentioned, a mobile device 102 having establish its orientation using reference frame 220 (e.g., via pre-processing operation, an update or refresh operation, etc.) may then transform (e.g., rotate, map, etc.) inertial sensor measurements (which relate to device-centric coordinate system 200′) to reference frame 220. For example, inertial sensor measurements corresponding to (x, y, and z) axes of device-centric coordinate system 200′ may be defined according to the (v, h, and t) axes of reference frame 220 using a rotation matrix based, at least in part, on eigenvectors indicative of a determined orientation.

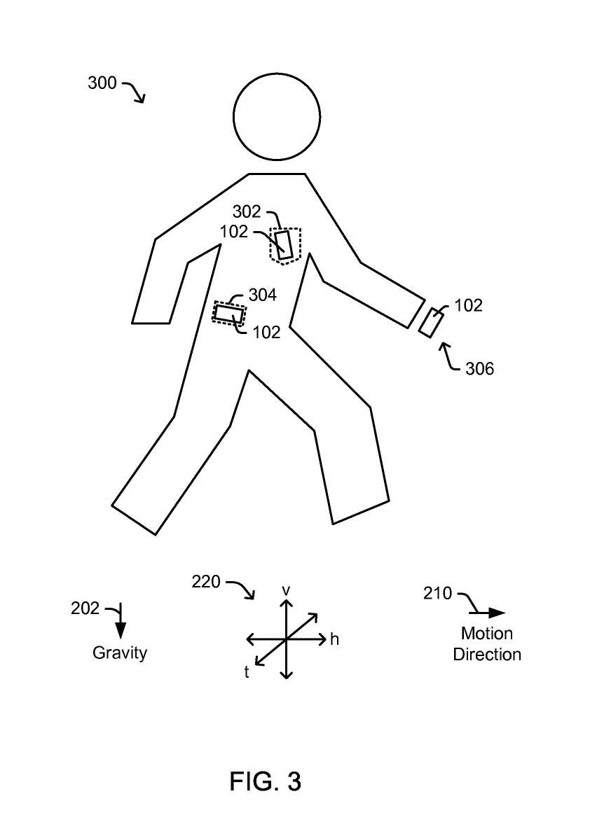

FIG. 3 is an illustrative diagram showing that a mobile device 102 may be arranged (stored, held, etc.) in various different positions with regard to user's body 300, in accordance with an implementation. For reference, FIG. 3 also includes gravity vector 202, motion direction vector 210, and reference frame 220. It is noted that reference frame 220 (as drawn in FIG. 3) is not intended to specifically relate to any of the various example orientations shown for mobile device 102.

As previously mentioned, in certain example implementations, a mobile device may estimate its position with regard to a walking or running user (e.g., a model of a user body) based, at least in part, on certain eigenvectors. By way of example, in certain instances, mobile device 102 may be in a position that may suggest a modeled torso level position of a user while in a container 302 (e.g., a shirt pocket, an upper jacket pocket, a high strung bag or purse, a lanyard, etc.). In other example instances, mobile device 102 may be in a position that may suggest a modeled waist level position of a user while in a container 304 (e.g., a hip holster attached to a belt, a pants pocket, a lower jack pocket, a low strung bag or purse, etc.). In yet other example instances, mobile device 102 may be in a position that may suggest a modeled hand-held position of the user while in a container 306 (e.g., one or more of the users hands, a hand-held bag or purse, etc.).

Determined eigenvectors and eigenvalues may, for example, be indicative of certain differences in detectable motions in various modeled positions with regard to a user body while walking or running. For example, an upper region of the user's body may not have as much sideward movement as might a hip region while the user may be walking or running. Thus, if a ratio between a second strongest eigenvalue and a third strongest (e.g., weakest) eigenvalue exceeds a threshold value, then such may be indicative that a mobile device may be more likely to be in an upper shirt pocket than in a pants pocket or in a hip-holster.

In another example, an alignment angle (e.g., a direction of motion with regard to a device-centric coordinate system in a horizontal plane) may be considered in an estimated a position of a mobile device with regard to a model of a user body. Assuming that a z-axis of device-centric coordinate system is orthogonal to a display 204 (e.g., see FIG. 2A), a z-axis may be used as a reference axis while considering how a mobile device may be placed or held in a position with respect to a user's body. For example, a user may be more likely to store or face a mobile device in certain positions/containers based on the display 204. For example, certain mobile devices are shaped according to their display (e.g., having a planar shape) and hence such a mobile device may be placed in a container in a certain manner that is predictable. For example a thin pocket may lend itself to having a smart phone placed/held in it in a certain orientation. Moreover, users often place a touch screen display or the like facing towards their body so as to avoid scratching it should they bump into or rub against some object. Hence, in certain positions a z-axis may be generally orthogonal to an estimated gravity vector of a reference frame while a user is standing, walking, etc. Thus, a second axis may be established based, at least in part, on taking a cross product of a z-axis and an estimated gravity vector. An alignment angle may, for example, be the angle between the z-axis and a projection of second strongest eigenvector onto plane defined by the z-axis and the cross product. For example, in certain instances an alignment angle of ˜0 degrees (or ˜180 degrees) may be indicative of a mobile device within shirt pocket (front, rear), while an alignment angle of ˜90 degrees (or ˜270 degrees) may be indicative of a mobile device within a hop-holster or side pants pocket.

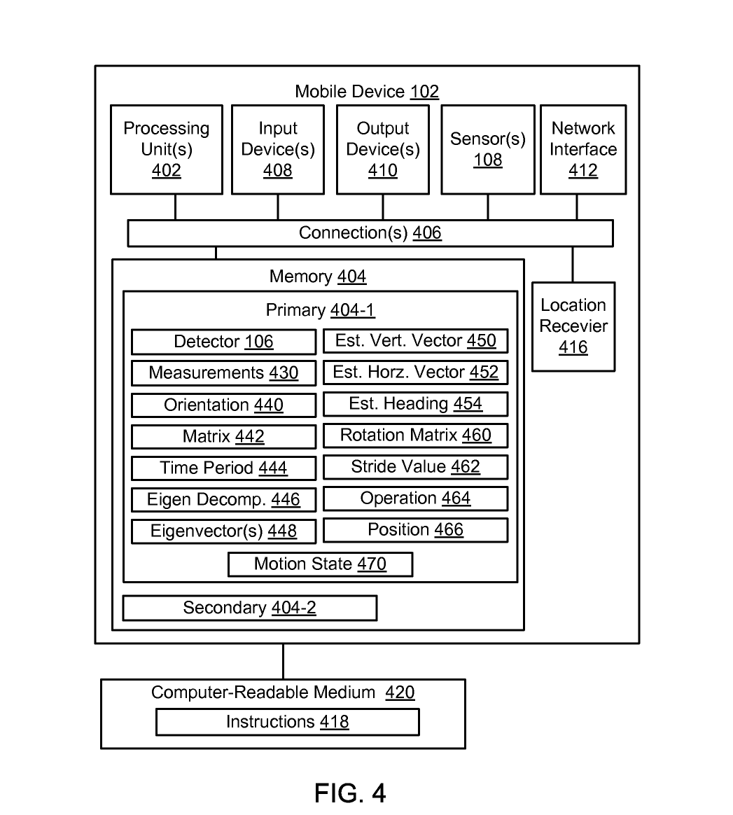

Reference is made next to FIG. 4, which is a schematic block diagram illustrating certain features of an example mobile device 102 capable of classifying its motion state based, at least in part, on measurements 430 from one or more inertial sensors 108, in accordance with an implementation.

As illustrated mobile device 102 may comprise one or more processing units 402 to perform data processing (e.g., in accordance with the techniques provided herein) coupled to memory 404 via one or more connections 406. Processing unit(s) 402 may, for example, be implemented in hardware or a combination of hardware and software. Processing unit(s) 402 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 404 may be representative of any data storage mechanism. Memory 404 may include, for example, a primary memory 404-1 and/or a secondary memory 404-2. Primary memory 404-1 may comprise, for example, a random access memory, read only memory, etc. While illustrated in this example as being separate from the processing units, it should be understood that all or part of a primary memory may be provided within or otherwise co-located/coupled with processing unit(s) 402, or other like circuitry within mobile device 102. Secondary memory 404-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, computer-readable medium 420. Memory 404 and/or computer-readable medium 420 may comprise instructions 418 associated with data processing (e.g., in accordance with the techniques and/or motion state detector 106, as provided herein).

In certain implementations, mobile device 102 may further comprise one or more user input devices 408, one or more output devices 410, one or more network interfaces 412, and/or one or more location receivers 416.

Input device(s) 408 may, for example, comprise various buttons, switches, a touch pad, a trackball, a joystick, a touch screen, a microphone, a camera, and/or the like, which may be used to receive one or more user inputs.

Output devices 410 may, for example, comprise a display 204 (FIG. 2A-B), such as, a liquid crystal display (LCD), a touch screen, and/or the like, or possibly, one or more lights, light emitting diodes (LEDs), a speaker, a headphone jack/headphones, a buzzer, a bell, a vibrating device, a mechanically movable device, etc.

Sensors 108 may, for example, comprise one or more inertial sensors (e.g., an accelerometer, a magnetometer, a gyrometer, etc.). In certain instances, sensors 108 may also comprise one or more environment sensors, e.g., a barometer, a light detector, thermometer, and/or the like

A network interface 412 may, for example, provide connectivity to one or more networks 104 (FIG. 1), e.g., via one or more wired and/or wireless communication links.

Location receiver 416 may, for example, obtain signals from one or more location services 110 (FIG. 1), which may be used in estimating a location, velocity, and/or heading that may be provided to or otherwise associated with one or more signals stored in memory 404.

At various times, one or more signals may be stored in memory 404 to represent instructions and/or representative data as may be used in the example techniques as presented herein, such as, all or part of: a motion state detector 106, various inertial sensor measurements 430, an orientation 440 (e.g., using a reference frame), a matrix 442, a time period 444, an eigendecomposition process 446, one or more eigenvectors 448 (and/or eigenvalues), an estimated vertical vector 450, an estimated horizontal vector 452, an estimated heading 454, a rotation matrix 460, a pedometer stride value 462, one or more operations 464, a position 466, and/or a motion state 470, just to name a few examples.

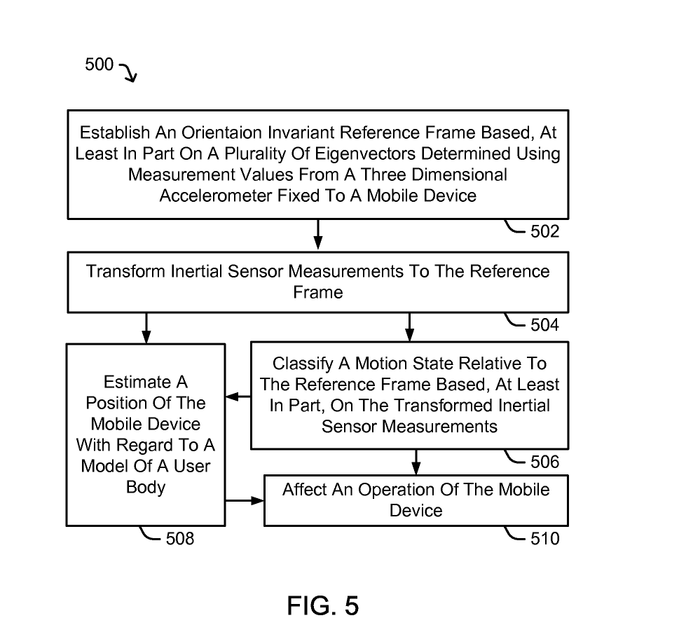

Attention is drawn next to FIG. 5, which is a flow diagram illustrating certain features of an example process 500 for use a mobile device 102 (e.g., having a motion state detector 106) to classify a motion state of the mobile device based, at least in part, on measurements from one or more inertial sensors 108, in accordance with an implementation.

At example block 502, an orientation invariant reference frame may be established. For example, a reference frame may have an estimated vertical vector corresponding to a first one of a plurality of eigenvectors having a greatest magnitude, and an estimated horizontal vector corresponding to a second one of said plurality of eigenvectors having a second greatest magnitude.

A plurality of eigenvectors may be based, at least in part, on measurement values from a three-dimensional accelerometer fixed to the mobile device. For example, a matrix of accelerometer measurement values (e.g., for a period of time) for a three-dimensional accelerometer may be established, e.g., by averaging the outer product measurements from a three-axis accelerometer. Eigendecomposition may then be performed on the matrix to determine a plurality of eigenvectors.

In certain example instances a rotation matrix may be established based, at least in part, on the eigenvectors. A covariance matrix may, for example, be computed as follows:

A=sum_{—}i([a_{—}x(i); a_{—}y(i); a_{—}z(i)]*[a_{—}x(i); a_{—}y(i); a_{—}z(i)]̂H)

If, for example, a sampling rate is 20 Hz and a duration over which averaging takes place corresponds to 2.5 seconds, then fifty samples will be averaged. Let A be a square (3×3) matrix with N=3 linearly independent eigenvectors, qᵢ (i=1, . . . , N). Then A may be factorized as A=QΔQ⁻¹ where Q is the square (N×N) matrix whose i^{th} column is the eigenvector qᵢ of A and Λ is the diagonal matrix whose diagonal elements are the corresponding eigenvalues, i.e., Λᵢᵢ=λᵢ.

There are various standard methods that may be used which perform factorization according to eigenvalue decomposition. Note that in this example A is a positive definite, symmetric matrix. Hence, specialized eigenvalue decomposition methods become applicable. Applicable methods such as Jacobi iterations are listed in the standard reference Matrix Computations by Golub and Van Loan. A largest eigenvector may, for example, correspond to the eigenvector with the largest eigenvalue. Eigenvalues of positive definite symmetric matrices are always positive. An example rotation matrix may correspond to Q, a matrix of eigenvectors. Other sensor readings may, for example, be rotated by multiplying the readings with the rotation matrix Q to achieve orientation invariance.

At example block 504 subsequent inertial sensor measurements from one or more inertial sensors may be transformed to a reference frame (e.g., from block 502). In certain example instances, inertial sensor measurements may be transformed to a reference frame using a rotation matrix.

At example block 506 a motion state relative to a reference frame may be classified (e.g., determined) based, at least in part, on transformed inertial sensor measurements (e.g., from block 504).

In certain example implementations, at block 508, a position of the mobile device (e.g., with regard to a model of a user body) may be estimated based, at least in part, on one or more eigenvectors, one or more transformed inertial sensor measurements (e.g., from block 504), a determined motion state (e.g., from block 506), and/or some combination thereof.

In certain example implementations, at block 510, an operation of a mobile device may be affected in some manner based, at least in part, on the estimated position of the mobile device with regard to a position (e.g., from block 508, and/or a motion state (e.g., from block 506).

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile device:
establishing a reference frame having an estimated vertical vector corresponding to a first one of a plurality of eigenvectors having a greatest magnitude and an estimated horizontal vector corresponding to a second one of said plurality of eigenvectors having a second greatest magnitude, said plurality of eigenvectors being based, at least in part, on measurement values from a three-dimensional accelerometer fixed to the mobile device;
transforming inertial sensor measurements to said reference frame; and
classifying a motion state relative to said reference frame based, at least in part, on said transformed inertial sensor measurements.

2. The method of claim 1, and further comprising classifying said motion state based further, at least in part, on at least one of: at least one of said plurality of eigenvectors, or at least one eigenvalue corresponding to said at least one of said plurality of eigenvectors.

3. The method of claim 1, and further comprising, at the mobile device:
classifying said motion state as one or more of turning left, turning right, increasing altitude, or decreasing altitude.

4. The method of claim 1, wherein said estimated horizontal vector represents an estimated heading of the mobile device, and said estimated vertical vector represents an estimated gravity vector.

5. The method of claim 1, wherein said measurement values from said three-dimensional accelerometer correspond to a period of time.

6. The method of claim 1, and further comprising, at the mobile device:
transforming said inertial sensor measurements to said reference frame using a rotation matrix based, at least in part, on said plurality of eigenvectors.

7. The method of claim 6, wherein at least a portion of said inertial sensor measurements comprise accelerometer measurements, and wherein transforming said inertial sensor measurements to said reference frame further comprises:
applying said rotation matrix to at least a portion of said accelerometer measurements to estimate a vertical change in a direction of motion of the mobile device.

8. The method of claim 6, wherein at least a portion of said inertial sensor measurements comprise gyrometer measurements, and wherein transforming said inertial sensor measurements to said reference frame further comprises:
applying said rotation matrix to at least a portion of said gyrometer measurements to estimate a horizontal change in a direction of motion of the mobile device.

9. The method of claim 6, wherein at least a portion of said inertial sensor measurements comprise magnetometer measurements, and wherein transforming said inertial sensor measurements to said reference frame further comprises:
applying said rotation matrix to at least a portion of said magnetometer measurements to estimate a heading change in a direction of motion of the mobile device.

10. The method of claim 1, wherein classifying said motion state further comprises:
determining whether a change has occurred in an estimated direction of motion of the mobile device.

11. The method of claim 1, and further comprising, at the mobile device:
estimating a position of the mobile device with regard to a model of a user body within said reference frame based, at least in part, on at least one of:
said plurality of eigenvectors,
said transformed inertial sensor measurements, or
said motion state.

12. The method of claim 11, and further comprising, at the mobile device:
affecting an operation of the mobile device based, at least in part, on said position.

13. The method of claim 1, and further comprising, at the mobile device:
affecting an operation of the mobile device based, at least in part, on said motion state.

14. An apparatus for use in a mobile device, the apparatus comprising:
means for establishing a reference frame having an estimated vertical vector corresponding to a first one of a plurality of eigenvectors having a greatest magnitude and an estimated horizontal vector corresponding to a second one of said plurality of eigenvectors having a second greatest magnitude, said plurality of eigenvectors being based, at least in part, on measurement values from a three-dimensional accelerometer fixed to the mobile device;
means for transforming inertial sensor measurements to said reference frame; and
means for classifying a motion state relative to said reference frame based, at least in part, on said transformed inertial sensor measurements.

15. The apparatus of claim 14, wherein said measurement values from said three-dimensional accelerometer correspond to a period of time.

16. The apparatus of claim 14, wherein said means for transforming said inertial sensor measurements further comprises:
means for transforming said inertial sensor measurements to said reference frame using a rotation matrix based, at least in part, on said plurality of eigenvectors.

17. The apparatus of claim 16, wherein at least a portion of said inertial sensor measurements comprise accelerometer measurements, and wherein said means for transforming said inertial sensor measurements further comprises:
means for applying said rotation matrix to at least a portion of said accelerometer measurements to estimate a vertical change in a direction of motion of the mobile device.

18. The apparatus of claim 16, wherein at least a portion of said inertial sensor measurements comprise gyrometer measurements, and wherein said means for transforming said inertial sensor measurements further comprises:
means for applying said rotation matrix to at least a portion of said gyrometer measurements to estimate a horizontal change in a direction of motion of the mobile device.

19. The apparatus of claim 16, wherein at least a portion of said inertial sensor measurements comprise magnetometer measurements, and wherein said means for transforming said inertial sensor measurements further comprises:
means for applying said rotation matrix to at least a portion of said magnetometer measurements to estimate a heading change in a direction of motion of the mobile device.

20. The apparatus of claim 14, wherein said means for classifying said motion state further comprises:
means for determining whether a change has occurred in an estimated direction of motion of the mobile device.

21. The apparatus of claim 14, and further comprising:
means for estimating a position of the mobile device with regard to a model of a user body within said reference frame based, at least in part, on at least one of:
said plurality of eigenvectors,
said transformed inertial sensor measurements, or
said motion state.

22. The apparatus of claim 21, and further comprising:
means for affecting an operation of the mobile device based, at least in part, on said position.

23. The apparatus of claim 14, and further comprising:
means for affecting an operation of the mobile device based, at least in part, on said motion state.

24. A mobile device comprising:
at least one inertial sensor to generate inertial sensor measurements, said at least one inertial sensor comprising a three-dimensional accelerometer fixed to the mobile device; and
a processing unit to:
establish a reference frame having an estimated vertical vector corresponding to a first one of a plurality of eigenvectors having a greatest magnitude and an estimated horizontal vector corresponding to a second one of said plurality of eigenvectors having a second greatest magnitude, said plurality of eigenvectors being based, at least in part, on measurement values from said three-dimensional accelerometer fixed to the mobile device;
transform inertial sensor measurements to said reference frame; and
classify a motion state relative to said reference frame based, at least in part, on said transformed inertial sensor measurements.

25. The mobile device of claim 24, wherein said measurement values from said three-dimensional accelerometer correspond to a period of time.

26. The mobile device of claim 24, said processing unit to further:
transform said inertial sensor measurements to said reference frame using a rotation matrix based, at least in part, on said plurality of eigenvectors.

27. The mobile device of claim 26, wherein at least a portion of said inertial sensor measurements comprise accelerometer measurements, and said processing unit to further:
apply said rotation matrix to at least a portion of said accelerometer measurements to estimate a vertical change in a direction of motion of the mobile device.

28. The mobile device of claim 26, wherein said at least one inertial sensor further comprises a gyrometer, and at least a portion of said inertial sensor measurements comprise gyrometer measurements, and said processing unit to further:
apply said rotation matrix to at least a portion of said gyrometer measurements to estimate a horizontal change in a direction of motion of the mobile device.

29. The mobile device of claim 26, wherein said at least one inertial sensor further comprises a magnetometer, and at least a portion of said inertial sensor measurements comprise magnetometer measurements, and said processing unit to further:
apply said rotation matrix to at least a portion of said magnetometer measurements to estimate a heading change in a direction of motion of the mobile device.

30. The mobile device of claim 24, said processing unit to further classify said motion state by determining whether a change has occurred in an estimated direction of motion of the mobile device.

31. The mobile device of claim 24, said processing unit to further:
estimate a position of the mobile device with regard to a model of a user body within said reference frame based, at least in part, on at least one of:
said plurality of eigenvectors,
said transformed inertial sensor measurements, or
said motion state.

32. The mobile device of claim 31, said processing unit to further:
affect an operation of the mobile device based, at least in part, on said position.

33. The mobile device of claim 24, said processing unit to further:
affect an operation of the mobile device based, at least in part, on said motion state.

34. An article comprising:
a non-transitory computer-readable medium having computer implementable instructions stored therein that are executable by a processing unit of a mobile device to:
establish a reference frame having an estimated vertical vector corresponding to a first one of a plurality of eigenvectors having a greatest magnitude and an estimated horizontal vector corresponding to a second one of said plurality of eigenvectors having a second greatest magnitude, said plurality of eigenvectors being based, at least in part, on measurement values from a three-dimensional accelerometer fixed to the mobile device;
transform inertial sensor measurements to said reference frame; and
classify a motion state relative to said reference frame based, at least in part, on said transformed inertial sensor measurements.

35. The article of claim 34, wherein said measurement values from said three-dimensional accelerometer correspond to a period of time.

36. The article of claim 34, said computer implementable instructions being further executable by said processing unit to:
transform said inertial sensor measurements to said reference frame using a rotation matrix based, at least in part, on said plurality of eigenvectors.

37. The article of claim 36, wherein at least a portion of said inertial sensor measurements comprise accelerometer measurements, and said computer implementable instructions being further executable by said processing unit to:
apply said rotation matrix to at least a portion of said accelerometer measurements to estimate a vertical change in a direction of motion of the mobile device.

38. The article of claim 36, wherein at least a portion of said inertial sensor measurements comprise gyrometer measurements, and said computer implementable instructions being further executable by said processing unit to:
apply said rotation matrix to at least a portion of said gyrometer measurements to estimate a horizontal change in a direction of motion of the mobile device.

39. The article of claim 36, wherein at least a portion of said inertial sensor measurements comprise magnetometer measurements, and said computer implementable instructions being further executable by said processing unit to:
apply said rotation matrix to at least a portion of said magnetometer measurements to estimate a heading change in a direction of motion of the mobile device.

40. The article of claim 34, said computer implementable instructions being further executable by said processing unit to classify said motion state by determining whether a change has occurred in an estimated direction of motion of the mobile device.

41. The article of claim 34, said computer implementable instructions being further executable by said processing unit to:
estimate a position of the mobile device with regard to a model of a user body within said reference frame based, at least in part, on at least one of:
said plurality of eigenvectors,
said transformed inertial sensor measurements, or
said motion state.

42. The article of claim 41, said computer implementable instructions being further executable by said processing unit to:
affect an operation of the mobile device based, at least in part, on said position.

43. The article of claim 34, said computer implementable instructions being further executable by said processing unit to:
affect an operation of the mobile device based, at least in part, on said motion state.
